(19) United States
(12) Patent Application Publication
(10) Pub. No.: US 2019/0329418 A1
(43) Pub. Date: Oct. 31, 2019

(54) SECURITY ROBOT

(71) Applicant: CROSSWING INC., Aurora (CA)

(72) Inventors: Stephen SUTHERLAND, Aurora, ON (CA); Philippe Guillaumont, Oakville, ON (CA); Daniel SUTHERLAND, Aurora, ON (CA)

(73) Assignee: CROSSWING INC., Aurora, ON (CA)

(21) Appl. No.: 16/349,644

(22) PCT Filed: Nov. 15, 2017
(86) PCT No.: PCT/CA2017/000246

§ 371 Date: May 14, 2019

Related U.S. Application Data
(60) Provisional application No. 62/422,237, filed on Nov. 15, 2016.

(51) Int. Cl. B25J 11/00; F41H 13/00; B25J 5/00; B25J 9/16

(52) U.S. Cl. CPC B25J 11/002; B25J 11/008; B25J 9/1694; B25J 5/007; F41H 13/00

(57) ABSTRACT

A security robot comprises a mobile base module with a head module supported in a raised position centrally above the mobile base. The head module includes an upwardly opening cavity interior thereto that receives an inter-changeable payload bucket unit. The inter-changeable payload bucket has a displaceable cap member movable between a closed position and an elevated position. The cap member in the closed position closes an upper surface of the payload bucket and conceals any payload enclosed therein. The cap member in the elevated position is positioned above and allows top access to any payload located in the payload bucket unit. Preferably, the mobile base is provided with a holonomic drive arrangement. An elevating platform can also be associated with the cap member and can support sensors and/or conflict devices. The ability to easily alter the payload increases the possible applications and/or allows for multipurpose applications.

This application claims priority from U.S. provisional patent application No. 62/422,237, filed on Nov. 15, 2016 and is incorporated by reference.

### FIELD OF THE INVENTION

The present invention relates to mobile robots and, in particular, to mobile security robots adaptable for different applications.

### BACKGROUND OF THE INVENTION

Mobile robots are increasingly being used and considered for applications where security personnel may be at high personal risk due to insufficient information. As a first step or part of a regular patrol, security robots can gather initial information for preliminary risk assessment before directly involving security personnel. Security type robots are now deployed for conventional or routine security applications including security patrols carried out in a host of facilities including shopping malls, resorts, amusement parks, homes, apartment complexes, warehouses and factories.

Security patrols are typically conducted at night or unattended times and act as a deterrent and early warning function to identify intruders in a restricted space. Even passive security applications may require the robot to include one or more defense mechanisms to avoid disablement. Security robots also have particular potential with respect to crowd control, crowd assessment and interaction.

Specifically, designed customized security robots are often considered, however, customized solutions are seldom cost effective. A security robot that is easily adapted and capable of being used in varying applications would be of assistance in expanding the applications. The mobile security robot, as disclosed in the present invention, addresses a number of disadvantages found in existing products.

### SUMMARY OF THE INVENTION

A security robot according to the present invention comprises a mobile base module and a head module with the head module supported at a raised position above the mobile base module. The head module includes a base member having a wall portion that defines an upwardly opening cavity interior thereto. An inter-changeable payload bucket unit is received in the upwardly opening cavity and the inter-changeable payload bucket unit having a displaceable cap member movable between a closed position and an elevated position. The cap member in the closed position closes an upper surface of the upwardly opening cavity and conceals the inter-changeable payload bucket unit. The cap member in the elevated position is spaced above and allows top access to any payload located in the payload bucket unit.

In a preferred aspect of the invention the inter-changeable payload bucket unit includes an elevating drive arrangement connected to a platform supporting the displaceable cap member. The elevating drive arrangement when activated moves the platform and cap member upwardly providing clear access to the upwardly opening cavity and the platform.

According to an aspect of the invention the platform is at least partially received and protected in the payload bucket unit when the cap is in the closed position.

In a further aspect of the invention the platform includes a plurality of sensing devices secured thereon, some of which having different or advantageous output signal content at the elevated position.

In yet a further aspect of the invention the platform includes one or more of a plurality of defensive and offensive devices secured thereon.

In an aspect of the invention the elevating drive arrangement includes two screw drive members that pass through the payload bucket unit and connect with the platform and raise or lower the platform with rotation of the two drive members.

According to an aspect of the invention an electric drive motor is a dedicated part of said drive arrangement and is removed as part of said inter-changeable payload bucket unit.

In a preferred aspect of the invention the inter-changeable bucket unit is a series of inter-changeable bucket units allowing any one of the inter-changeable bucket units to be exchanged with one of the inter-changeable bucket units secured in the mobile security robot.

In a different aspect of the invention a plurality of outwardly projecting rings are provided and selectively driven for spinning about a vertical axis of the security robot.

Preferably the projecting rings, when driven, rotate in opposite directions and similar speeds to increase vertical stability of the security robot.

In an aspect of the invention the projecting rings include outwardly projecting light transmitting members with angled surfaces capable of damaging or cutting surfaces brought into contact with the projecting rings when driven.

In a preferred aspect of the invention said projecting rings, when driven, create at least one of a flashing light transmission or an audible warning signal.

In a particularly preferred aspect of the invention said mobile base is an omni wheel mobile base.

In a further aspect of the invention the mobile base provides holonomic movement.

In a different aspect of the invention the security robot includes a series of time-of-flight sensors used to assist movement of the mobile security robot in a restricted space.

According to an aspect of the invention the security robot includes directional sensors in combination with rotational movement of the security robot to increase a desired scan area.

### BRIEF DESCRIPTION OF THE DRAWINGS

Preferred embodiments of the invention are shown in the drawings, wherein:

FIG. 1 is a perspective view of the security robot;

FIG. 2 is a front view of the security robot with the head of the security robot raised to an observation type position;

FIG. 3 is an exploded front view showing the modular assembly of the security robot;

FIG. 4 is a perspective view of the internal components of the base of the security robot showing the various battery supplies supported on a platform above the driven wheels;

FIG. 5 is the perspective of a cover used for the modular base of FIG. 4;

FIG. 6 is a perspective view of a reinforced leg portion applied over the base cover of FIG. 5;

FIG. 7 is a top perspective view of a rain cover used to cover the top of the base module;

FIG. 8 is a perspective of the transition module;

FIG. 9 is a perspective view of the neck module; FIG. 10 is a perspective view of a lower portion of the head module;

FIG. 11 is a sectional view through the lower portion of the head module as shown in FIG. 10;

FIG. 12 is a perspective view of a displaceable cap portion of the head;

FIG. 13 is an exploded perspective view of a bucket module that is received within the head module;

FIG. 14 is a sectional side view of the bucket module;

FIG. 15 is a front of the bucket module;

FIG. 16 is a front view of a modified bucket module;

FIG. 17 is a front view of the head module with the cap portion partially raised;

FIG. 18 is a sectional side view of the security robot; and

FIG. 19 is a perspective view of a modified security robot with spinning rings;

FIG. 20 is a perspective view of a security robot with additional spinning rings;

FIG. 21 is a perspective view of an assembled spinning ring; and

FIG. 22 is an exploded perspective view of a spinning ring.

### DETAILED DESCRIPTION OF THE PREFERRED EMBODIMENTS

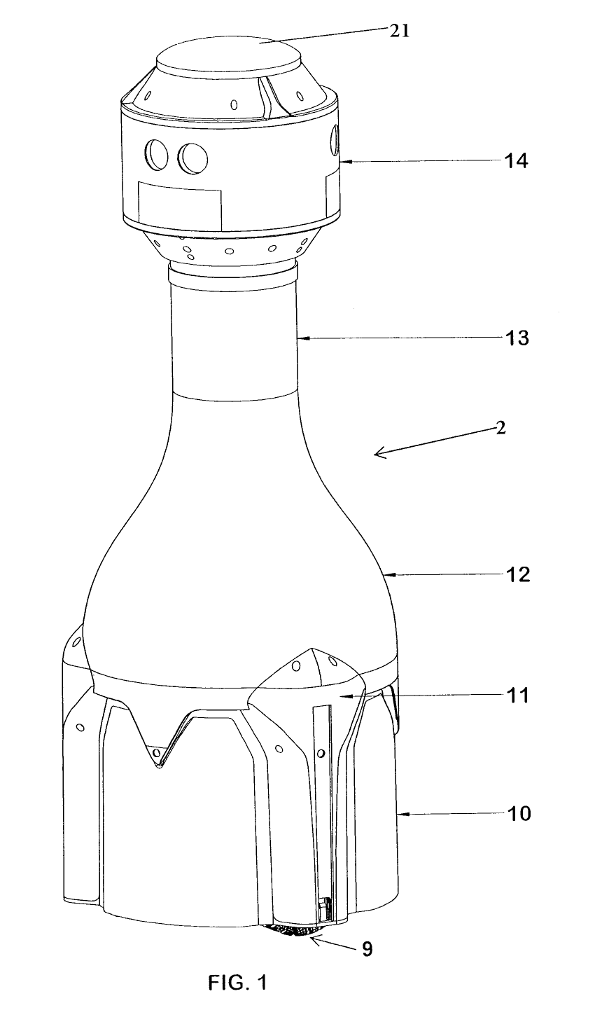

The mobile robot 2, shown in FIGS. 1, 2 and 3, includes a base module 10, a transition module 12, a neck module 13 and a head module 14. The base module 10 includes three omni wheels provided 9 around the base module 10 providing effective holonomic movement of the robot. Holonomic movement is advantageous to accurately position and move sensors mounted in or on the robot as part of a scanning function. In the present application, sets of omni wheels are shown and are preferred to increase the load carrying capability, distribute the load and add stability.

Column channels 11 reinforce the housing adjacent the axles and preferably support and protect various sensors adjacent the periphery of the base module robot. These sensors may assess the robot's immediate environment, possible drive paths, potential obstacles and/or carry out other specialized sensing functions, particularly adjacent ground level.

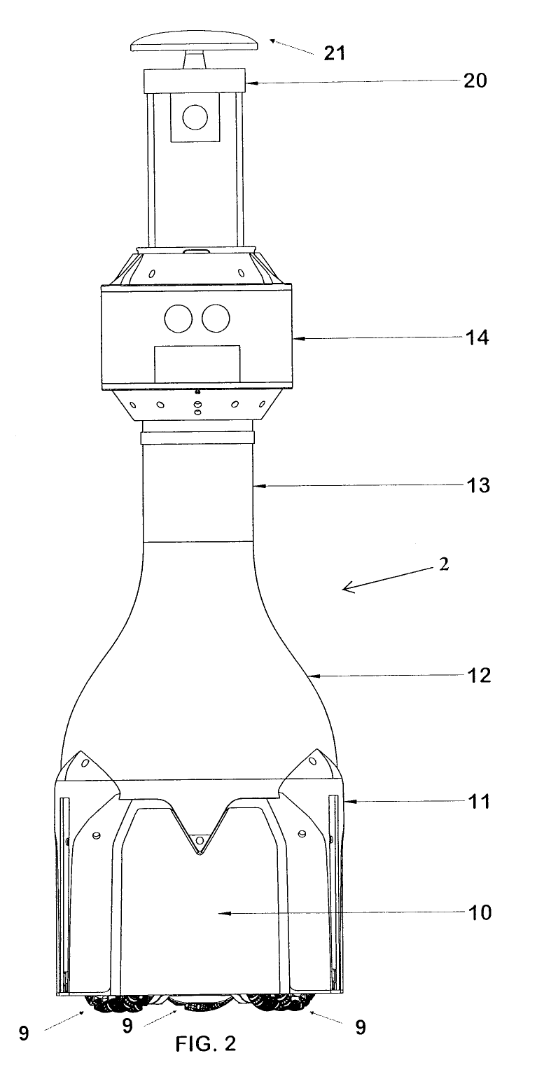

The security robot 2, shown FIGS. 1 and 2, is preferably of a generally concentric design and does not have a traditional dedicated front and back with respect to movement or sensing direction. For passive security type applications and/or public assistance applications, the robot can provide guidance or directions without normally requiring a change in orientation. If a small rotational is required the holonomic motion capability is able to complete these adjustments efficiently. If the robot provides directions by actually leading in a particular direction, the holonomic motion capability allows the robot to move in that direction without initially turning. The generally symmetrical design is preferred for many applications and can reduce response time as the need to initially turn is reduced or eliminated and more environmental information is known as more peripheral sensors are provided. The ability to initially move in a particular direction without turning is advantageous even if there is a preferred face direction of the robot that can be assumed as the robot moves.

A unique feature of the security robot 2 is shown in FIG. 2, where an elevating platform 20 of the head module 14 has been raised to provide enhanced assessment of environmental conditions including for example, crowd assessment, targeted individual assessment or recognition, and/or crowd movement and behavior and/or security information. The elevating platform can be equipped with defensive and offensive armaments. FIG. 1 shows the elevated platform 20 in the retracted position with the cap 21 generally closing and preferably sealing a top surface of the head module. In the retracted position, the platform 20 is partially received and protected in the upwardly opening cavity 251 of the main housing 250. Sensors 262 on the lower surface of the platform are fully protected.

The elevated position of FIG. 2 provides access to an upwardly opening bucket unit 30 that is centrally disposed within the head module 14. The bucket unit 30 can receive different types of payloads and access to these payloads can be restricted by maintaining the cap 21 in the retracted position of FIG. 1. Any payload contained within the bucket unit is not immediately known. The bucket unit is also removable or can be installed as a closed unit such that the payload, if any, is not known.

The elevating platform 20 of FIG. 2, even if a payload is not present, allows cameras, other sensors and other devices 260 (including Tasers, lasers, gas canisters, 360 degree scanners, high pressure water pistols, guns, stink bombs, fogging systems and both visible and invisible paint guns) to be moved to a raised position relative to the retracted height of the robot. In the higher position, these devices often operate in an improved manner above crowds, many vehicles and most fences and walls. Cameras raised to an elevated position often provide additional information which is not available at lower positions. For example, the elevated position would be particularly helpful in assessing crowd movements and crowd positioning and/or individuals within a crowd. In the raised position cameras may also view down and over people close to the robot. A security robot could be made with an increased fixed height, however, this approach raises the center of mass and significantly impacts stability and diversity.

Stability and a lower center of gravity is particularly important when demands for rapid traversal of longer distances require higher speeds and in cases where the direction of travel must be quickly and fluidly changed to avoid dynamic obstacles, such as people or projectiles thrown into the path of the robot. The elevated platform includes a brushless DC motor which powers a very quick lower back into the bucket as soon as a motion command demanding high speed traversal of the base along a path executes, and then redeployed quickly upwards when the motion of the robot subsides. Likewise, crowd uprisings recognized by onboard AI algorithms can trigger a rapid descent of a payload to protect expensive equipment. Preferably, an additional height of up to about six feet or greater can be provided and supported during periods of stationary or slow base motion, however, an additional three feet is often sufficient with a robot height in a retracted state of about five feet.

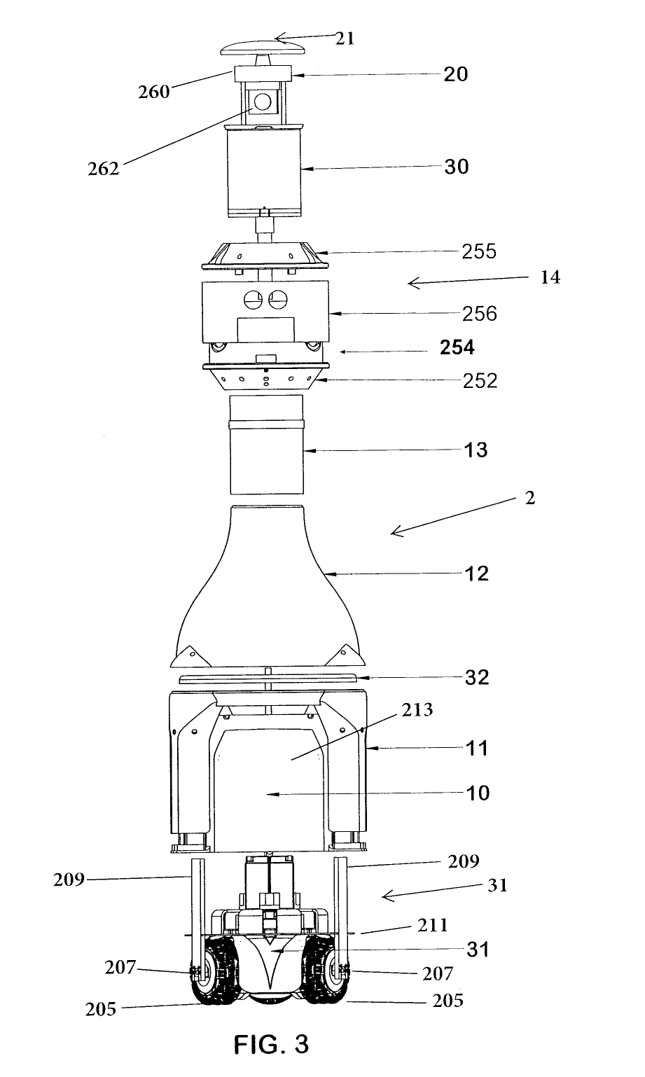

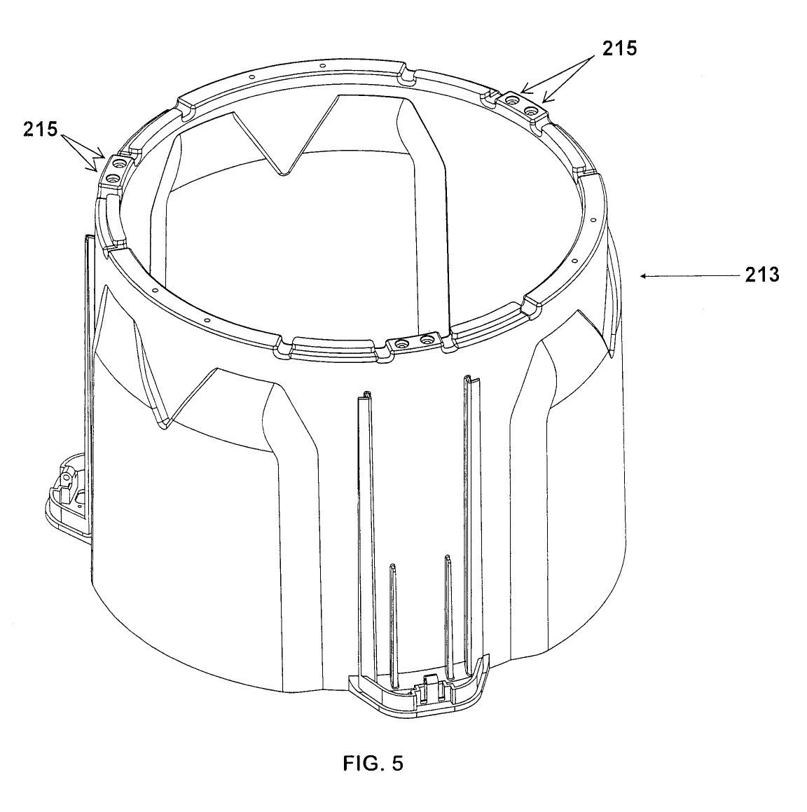

Further details of the security robot 2 are shown in the exploded assembly view of FIG. 3. The base module 10 includes the mobile platform 31 having omni wheels 205 supported by a triaxle arrangement. Axle sections 207 extend through the wheels and have vertical supports 209 connected to the ends of the axles. The vertical supports 209 engage the center platform 211 and extend upwardly therefrom and are secured interior to the base cover 213. The position of the vertical supports 209 is generally aligned with the outer column channels 11. The upper surface of the base cover 213, as shown in FIG. 5, includes securement ports 215 for connection with the ends of the vertical supports 209. The vertical supports 209 provide increased structural integrity to the base cover 213 and the column channels 11. The base cover 213 is preferably of a molded plastic and includes exterior areas and ports for receiving sensors.

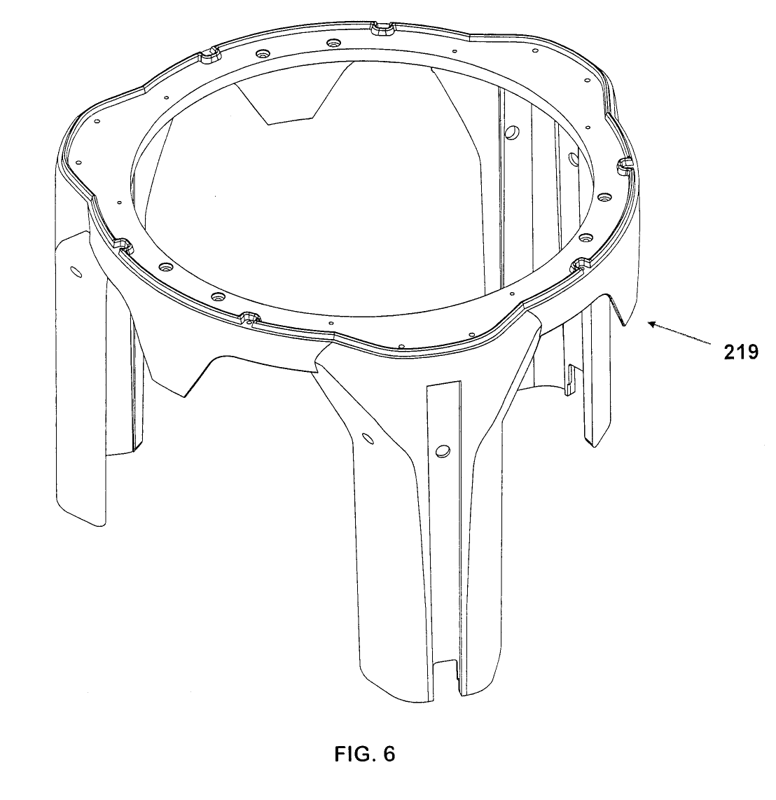

FIG. 6 shows a reinforcing member 219 that cooperates with and reinforces the base cover 213 particular with respect to wheel support and in locating sensors adjacent the wheels.

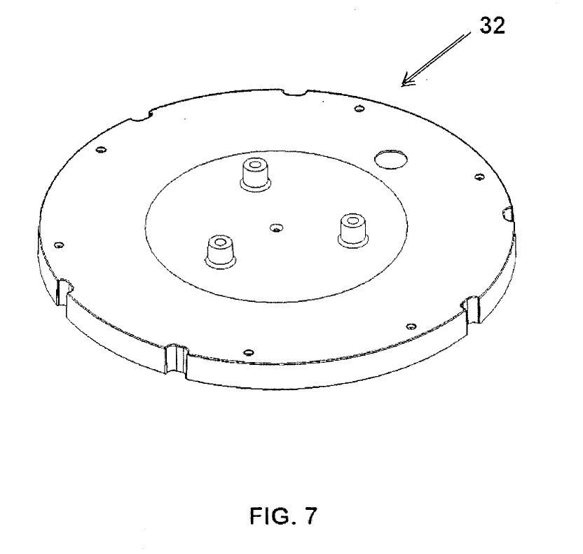

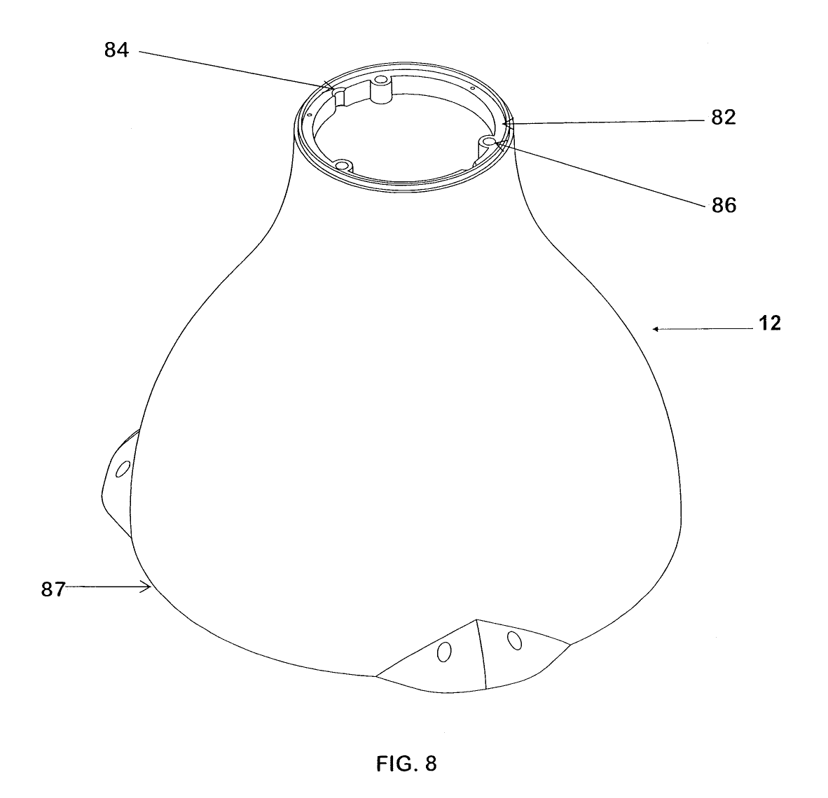

The rain cover 32 is shown in detail in FIG. 7 and acts to cover the top surface of the base module 10 that includes batteries and other electronic components sensitive to moisture and includes a snorkel arrangement (commonly used on off-road trucks and ships to ventilate engine compartments, not shown) to enable air flow past the cover. The base module preferably includes a holonomic drive arrangement as well as redundant components of the information processing and communication functions.

The transition module 12 and the neck module 13 are preferably fabricated of resilient lightweight molded plastic exoskeleton components and have two primary purposes: 1) they raise the position of the head module 14 to an elevated position centrally above the base module, while adding relatively little weight, contributing to the robot's low center of gravity; and 2) they are also designed to afford space to house sensors, such as metal detectors, about their periphery (clear of any elongated bucket unit 30 described later (FIG. 3)). By placing sensors inside the circumference of such transition and neck modules, these sensors can cost-effectively achieve a full 360 degree scan without necessitating a more complex rotating 360 degree mechanism. Additionally the sensors are located at an appropriate height for scanning pockets, briefcases, and backpacks of people passing near the robot. Since the holonomic motion platform enables the robot to rotate about its vertical axis while in a fixed location or while moving in a straight or other path, any sensor otherwise having a fixed scanning area is now able to scan in a 360 degree manner, if mounted within the robot. Furthermore, with current robotics navigation algorithms, while the robot passes close to people in airport queues, at checkpoints, walking through doorways entering buildings or security areas, the robot can simultaneously move close to these people and rotate such that internal sensors are in very close proximity to such people. These modules are also designed such that these internal sensors, when desired, can be rapidly moved up and down vertically while scanning within the peripheral areas of the transition module 12 and neck module 13, riding on linear rails or if equipped with appropriate current and signal carrying rails which spiral upwards and downwards within these modules as the robot rotates. Internal spiral rails following the inside of these curved exoskeleton components, permit the robot to rotate continuously, while the sensor, acting in unison, is riding such rails to maintain its orientation in a given direction: thus the sensor effectively moves up and down while facing one direction. Alternatively, the sensor could ride the interior spiraling rails in the same clockwise or counter-clockwise direction as the motion of the robot and thus have its net speed of rotation and up and down motion multiplied by the rotation of the robot, enabling very fast 360 degree scanning from scanner modules otherwise unable to deliver a 360 degree scan.

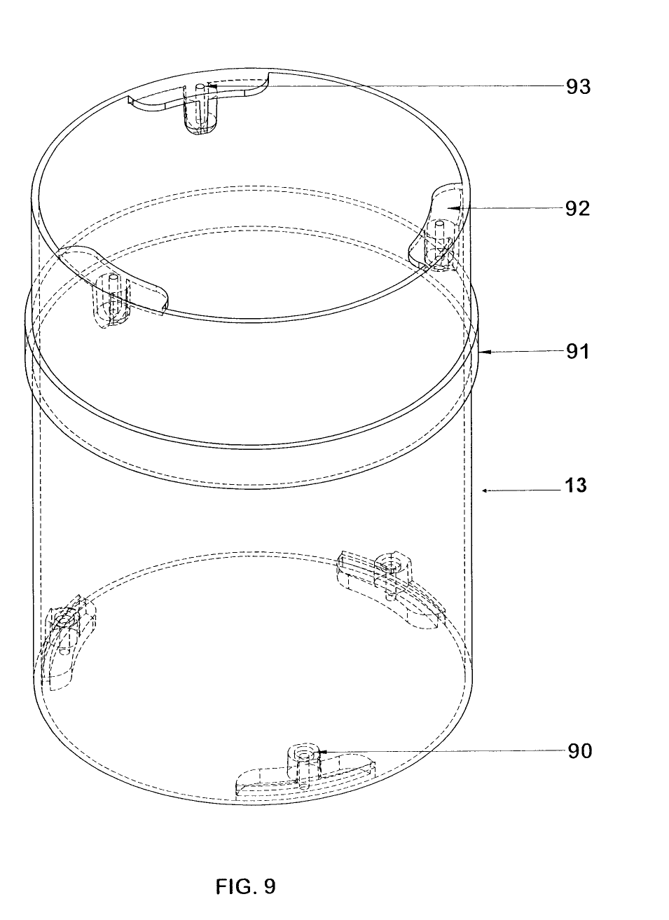

The neck module 13 in FIG. 9 is tubular with ported securing legs 90 for securement to the transition module 12. Upper mounting lugs 92 and 92 allow mechanical connection to the head module 14. Securing recess 91 can be used to mount a spinning ring that is described in later figures. The transition module 12 includes an upper ring connection portion 82 and connecting ports 86 for connecting and securing the neck module 13. The lower edge 87 connects and is mechanically secured to the base module 10. Notch 84 accommodates threaded drive tubes associated with the bucket unit.

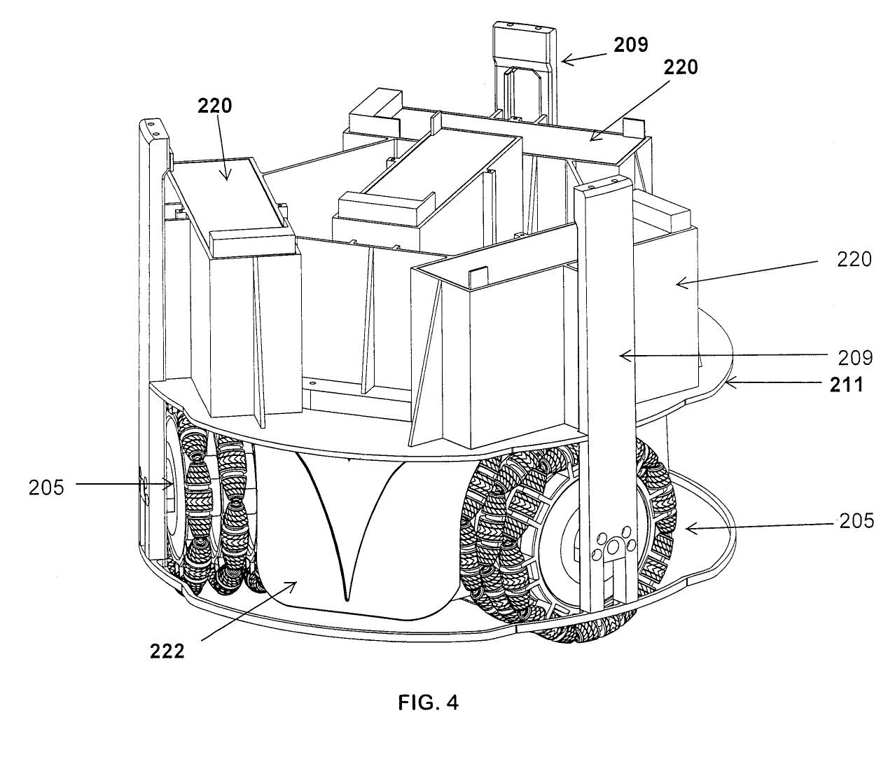

The base module 10 preferably includes separate drive motor arrangements for drive of the omni wheels 205 and the base module supports batteries located in the battery compartments 220 near the outer sides of the base for increased stability as shown in FIG. 4. A drive motor for one set of omni wheels is in the lower position generally indicated as 222 and the motor is offset from the particular omni wheel it is connected to via a toothed belt. Each of the omni wheels are separately driven. By providing the base platform with both the drive batteries and drive motors, the center of mass of the mobile robot is low and additional stability of the robot with respect to tipping is realized. The omni wheels also allow the mobile security robot to move in any direction in the plane of the support surface in response to an unexpected external force. Such freedom of movement reduces the likelihood of a tripping or flipping action of the robot.

Further details of the head module 14 are shown in FIGS. 10 through 16. The main housing 250 includes a lower transition portion 252 forming an overlapping connection with the neck module. The main housing 250 includes the projecting ring or cylinder wall 254 that receives a cylindrical cover portion to protect sensors that are mounted in the main housing 250. The cylindrical wall 256 includes various mounting ports 101, 102 and 109 that can receive different types of sensors or devices for assisting in assessing the environment about the security robot and to assist in safe movement of the security robot. The cap ring 255 defines the center recess for receiving the bucket unit.

The ports 101, 102 and 109 are preferably provided in pairs to deliver seamless 360 degree 3D video streams when used with stereo vision imaging sensors and are symmetrically disposed about the main housing 250 at 120 degree intervals or more frequently, depending on their field of view. As previously mentioned, it is desirable for the security robot to be multi-directional, delivering true holonomic motion. By providing spaced sensors about the main housing, surrounding information centered in any intended direction is immediately available to vision processors and remote operators, should the security robot be required to move in a particular direction. For example, if the robot is considering movement in a direction 120° from its present directional path, there are sensors that are located to more accurately assess the environment in that particular direction. The drive direction can change without a required rotational movement of the robot about its central axis. Lugs 107 are for securing the cap ring 255.

For some applications, it is desired that in addition to transitional movement of the robot, the robot also employs a rotational movement and/or partial random type movement. With additional movements, the movement path of the robot is less evident or predictable. For example, if someone is trying to disable the robot, uncertainty with respect to its exact position or movement makes the task of ambush and disablement more difficult. Rotational movement of the robot can be used in combination with a directional sensor to increase the sensed area or a predetermined area to be scanned.

It can also be appreciated that the main housing 250 can be made of a suitable injection molded plastic and can be relatively strong while providing a suitable support ring for sensors which face outwardly. The interior of the main housing 250 can also be used for protecting the electrical connections of the sensors which are typically connected to a circuit board and processor provided in the head module connected to the base module 10 via USB-C providing power and data connectivity with the base. The larger sensor ports 100 are typically for mounting of speaker equipment or large sensors. Although plastic injection molded parts are suitable for most applications, higher strength, more durable materials can be used as required.

Additional details of the bucket unit 30, shown in FIG. 3, can be appreciated from a review of FIGS. 12 through 16. The bucket unit 30 is received in an upwardly opening cavity 251 of the main housing 250 of the head module. The bucket unit 30 preferably is removable from the main housing 250 allowing exchange with other preloaded bucket units. The bucket unit 30 is received in the main housing 250 and can include its own payload selected for the particular application. For many security applications, there may be no need to include a secret or concealed payload and, thus, the bucket will be empty.

For other applications, different payloads can be provided. For example, it may be desirable to include an appropriate irritant payload that could be released. Tear gas could be a particular payload for anticipated or potential conflict applications to dissipate a crowd. For military applications, the payload may be much more aggressive and include a more sophisticated arrangement for releasing of the payload. The head module includes a bucket unit that can include a payload and it is preferably not possible to recognize what mobile security robots include payloads. Therefore, if there are multiple robots it is not possible to determine which robots include a payload or which mobile security robots should be targeted to be disabled. The payload has been described with respect to defensive type applications, however, it may be appropriate to deliver a payload to a particular location. This design allows for varied applications.

In addition to the ability to conceal a payload interior to the head module and separated from the sensors, the interchangeable bucket unit 30 allows for the cap 21 of the head module 14 and related equipment thereof to be raised. Such a raised position of the cap is shown in FIGS. 2 and 3. In some cases, the bucket unit may be separately covered or locked.

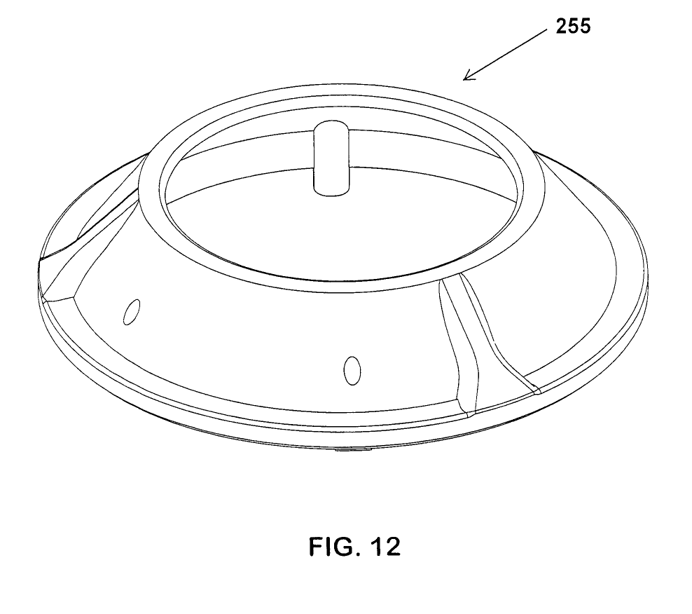

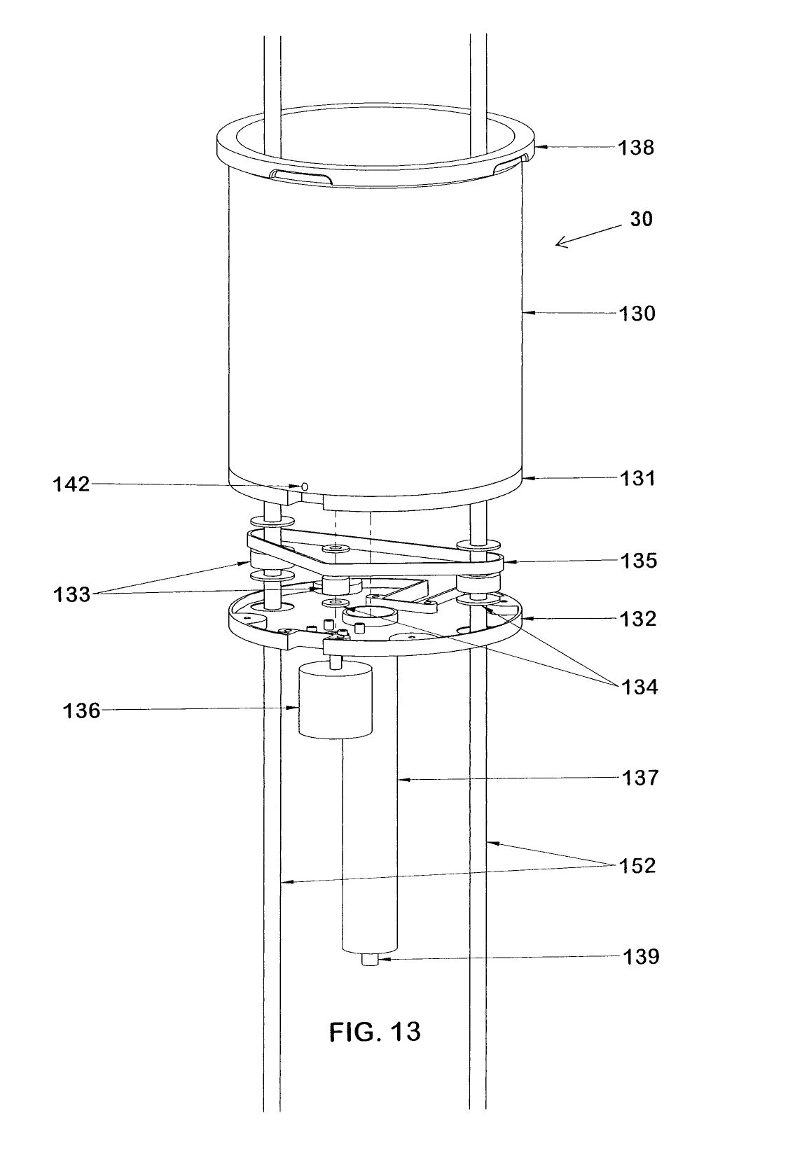

FIG. 13 shows the bucket unit 30 and an elevating drive arrangement. The elevating drive arrangement includes the drive motor 136, drive belt 135 and drive pulleys 133 used to rotate the threaded drive tubes 152. The drive tubes 152 pass through the bucket unit 30, however, the bucket vessel remains in place. The drive tubes are essentially screw threads that raise the ends of the drive tubes and raise the platform 260. The sensing arrangement 262 is supported on the platform together with cap 21 which seals the head module when it is lowered to the concealed position of FIG. 1.

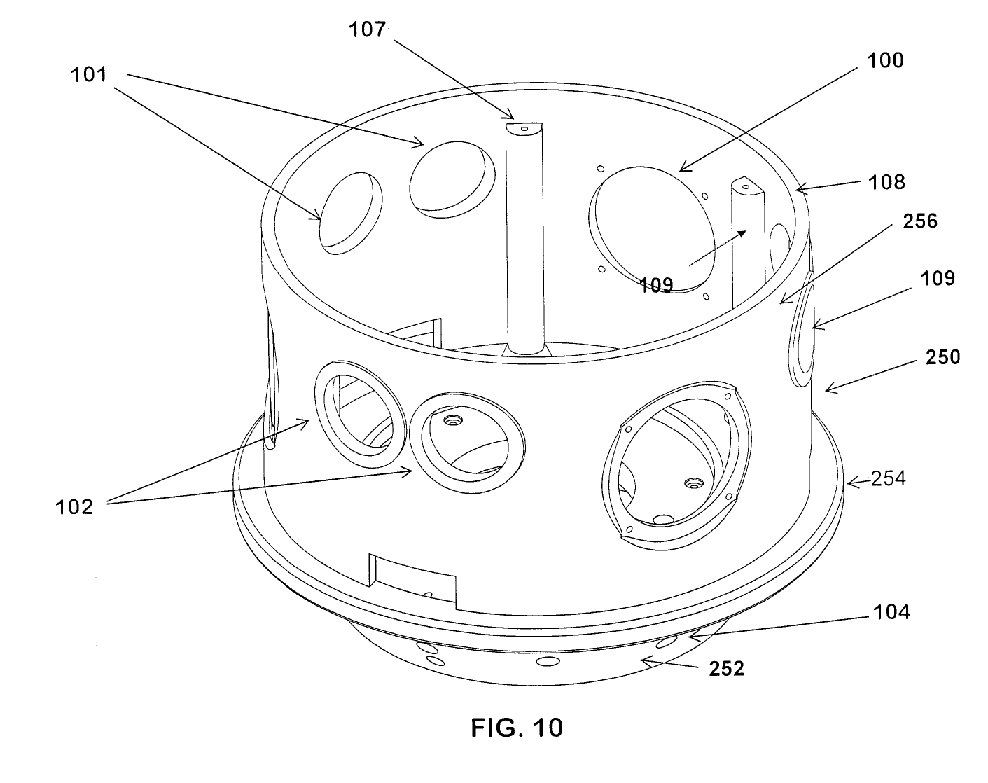

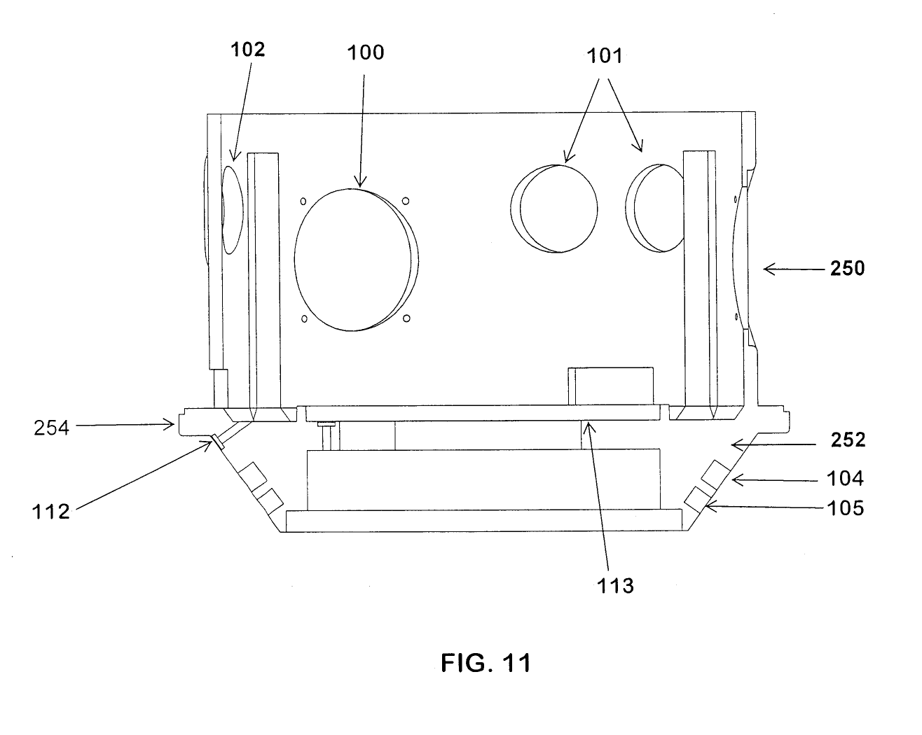

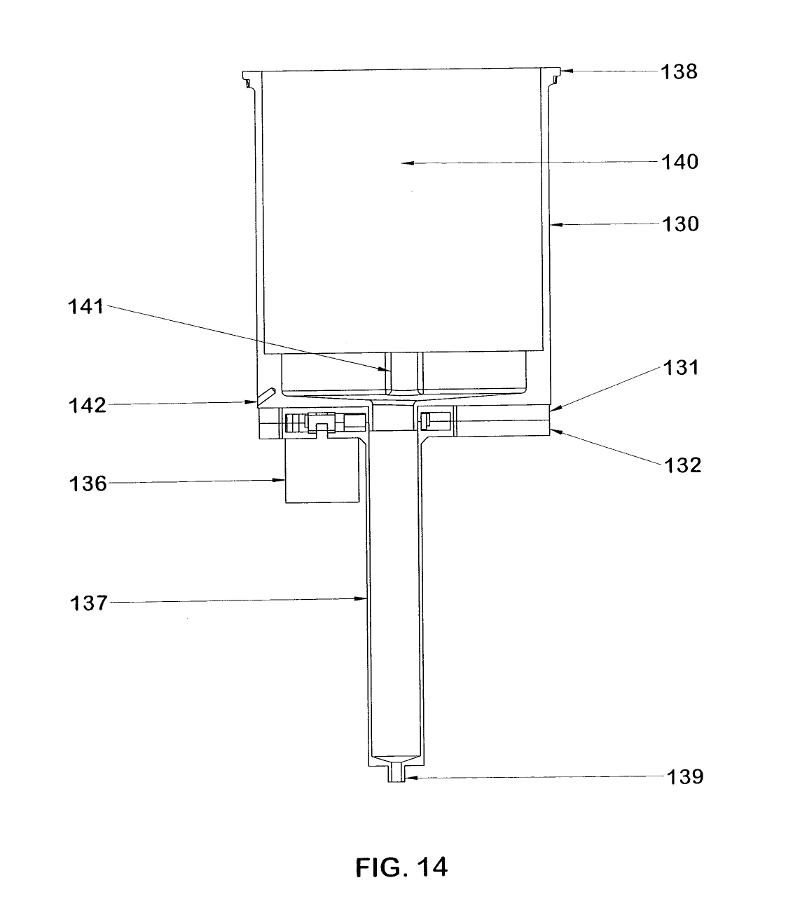

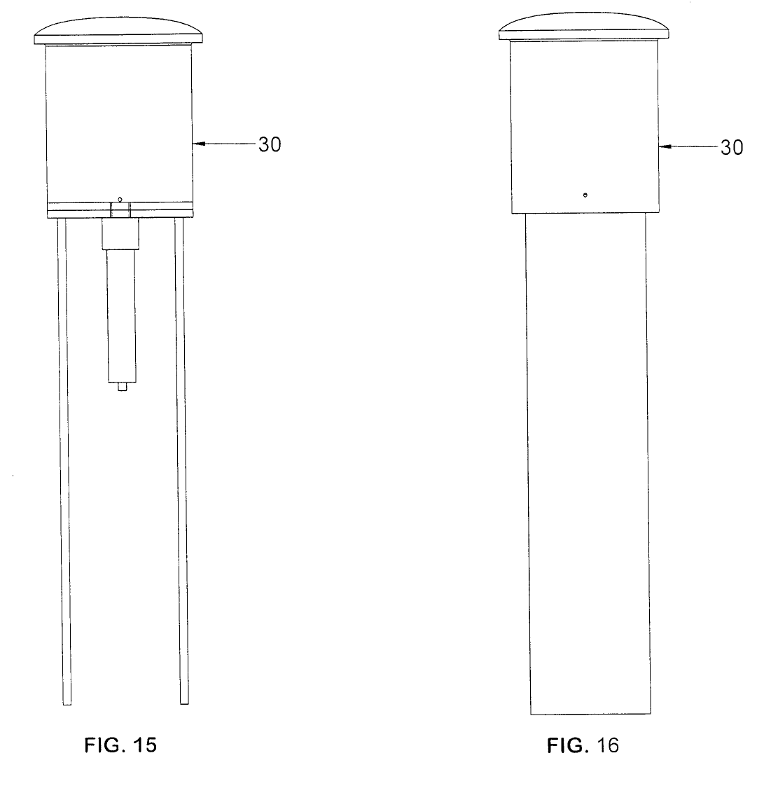

With this arrangement, the bucket unit is interchangeable merely by appropriately connecting the USB-C power and data wire from the drive controller of the bucket unit to the processor card in the base module and inserting and securing the bucket unit with three security-head bolts 112 (FIG. 11) screwing into holes 142 (FIGS. 13 and 14) in the bucket edge 130 at the bucket base 131 to affix it within the modular head. As can be appreciated from a review of FIGS. 15 and 16, the bucket unit 30 can be sealed at edge 138 whereby personnel installing the bucket units, have no way to know the details of the payload that is contained within the particular bucket unit—such bucket units are only visually identified by a ‘unit id’ printed on their outer case and packaging material.

Tube extension 137 acts as a central drain and a flexible tube can be connected to tube connector 139. The tubes 170 can pass through the base module and drain.

Bucket units are shipped to field or service installation facilities in a lowered (capped) position and can only be raised, after installation when appropriately encrypted command data and power is delivered via the USB-C cable and thus, the contents of the bucket unit cannot be specifically known by such installation technicians. Different loaded bucket units can be available for loading in a security robot and thereby the particular adaption of the security robot for its particular environment can easily be varied. The bucket unit of FIG. 16 includes an extended bottom portion for receiving longer payloads. For example, it may be desired to include rifle equipment having an elongated barrel which can be received within the modified bucket unit. Different types of bucket units and payloads can be used including Taser units. For some applications, deploying of permanent type skin marking ink could be shot from the robot, from a briefly raised payload apparatus, and used by manual remote control by operators in a remote command center or autonomously deployed by AI algorithms operating in the cloud or locally on processors within the robot to semi-permanently identify particular individuals.

Software security preventing unauthorized deployment of hidden payloads within bucked units is specific to the type of payload. All payloads respond to a “query id” command from the robot delivered via encrypted communications over the USB-C cable which returns only the ‘unit id’; such communications are encrypted via the public encryption key associated with such ‘unit id’. This unique unit id is used to verify that a desired payload is installed within a given robot. Payloads such as pan-tilt-zoom camera systems will respond to a “query payload” command from the robot delivered via the USB-C cable after receipt of an authorization code uniquely set for its given unit id and similarly execute raise, lower, and operational commands. However, some payloads require additional authorization codes for specific operations and those payloads equipped with GPS are geofenced as to the accessibility of certain operations such as data dump and fire commands. These authorization codes, and even the public encryption keys associated with a given unit id are not usually stored in the robot, and are maintained by secure operations centers.

Some payloads contain their own supplemental battery systems to power internal payload “black boxes” and emergency systems which recharge when power is available via a USB-C connection. For example, some payloads may self-destruct if they lose a ‘heartbeat’ or other signal from their host robot, or if they discover that they have been taken outside of a predefined geofenced area.

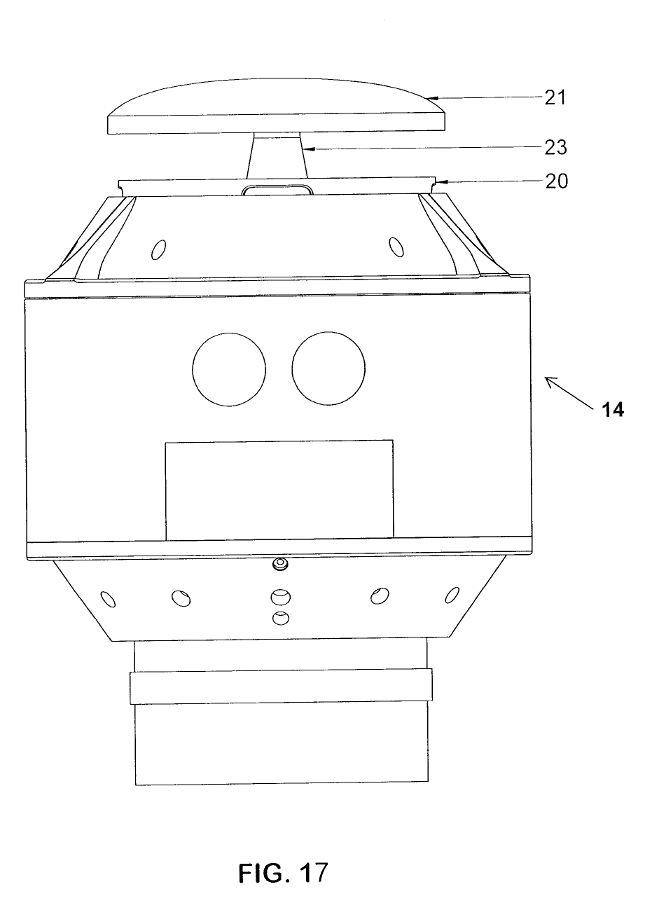

FIG. 17 shows the platform 20 and the cap 21 partially raised with a substantial portion of the platform still received in the bucket unit or the upper portion of the head. A sensing cluster 23 has been exposed for improved performance.

The head module with interchangeable bucket units each incorporating embedded motor drives, makes the exchange of the bucket units a simple and straightforward task. It can also be appreciated that the drive for the elevating mechanism for the individual bucket units could be part of the security robot itself and the rotational parts would form a releasable drive connection with the motor when inserted in the head module. The head module with the elevating platform with or without the bucket unit, also simplifies adaption of the robot for different applications.

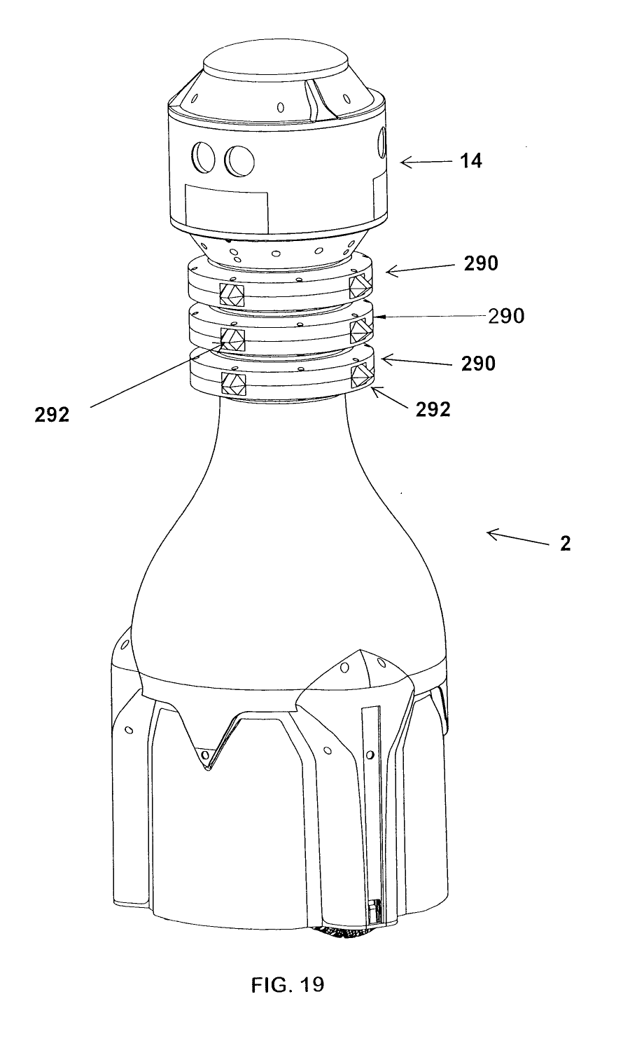

One particular concern for a security robot is the possibility of crowds or individuals disabling the robot by tipping the robot over. As previously disclosed, the base module includes all of the heavy components, however, the possibility of toppling the security robot still exits. For some security robot applications, spinning disks (FIGS. 19, 20 and 21) are provided that are selectively driven to reduce the possibility of the robots being pushed over. The spinning disks are provided on the upper portion of the mobile robot and, when driven, rotate at relatively high speed. Lights can be provided on the rotating members which include small projections designed to cause damage should a person seek to touch or push at these locations. Certain types of deterrents or caution provisions may be employed with the spinning disks such as lights which spin with the disks making the spinning disks easily recognizable or signaling patterns visible from longer distances. Sound generating capabilities can be provided that are functional when the disks spin or are about to be driven. High frequency audible devices can also be provided as an indicator of danger and to encourage individuals to distance themselves from the security robot. The spinning disks can also be charged to provide an electric shock, if contacted directly.

For some crowd control applications, defensive mechanisms are not appropriate, however, somewhat passive defense mechanisms can be provided. For example, a siren, flashing lights or high power lights, paint ball type marking and/or video capture to record anyone seeking to damage the robots may be sufficient to act as a deterrent. For military applications, more sophisticated deterrents and aggressive capabilities can be provided as part of the concealed payload or visible defense mechanisms.

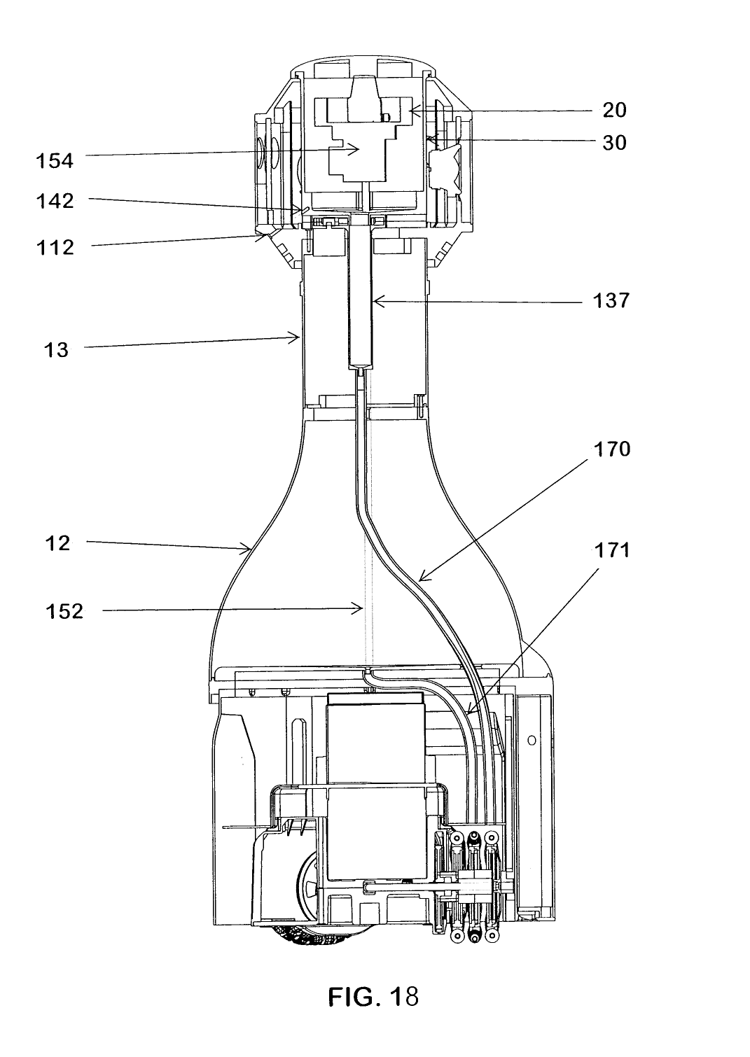

The mobile robot of FIG. 18 includes a separate drive shaft 152 connected to motor 155. The drive 152 connects to a particular payload 154. This payload could be a Taser or other device that requires additional control or drive transmitted by drive 152. For example, controlled rotation may be necessary to appropriately aim and activate the payload.

FIG. 18 also shows a drain tube 171 used to drain the rain cap.

The mobile robot 2 of FIG. 19 includes three spinning disks 290 provided on the neck module 30. These disks each rotate separately and it is preferable that each adjacent disk rotates in the opposite direction. Each spinning disk 290 includes an outwardly projecting prism type member 292 or more aggressive member like a steel knife edge. A series of light sources are provided on the surface of each spinning disk 290. Different colours of light can be provided.

Protection of the neck portion 13 and the head module 14 is important as the position of these modules above the base module acts as an effective lever.

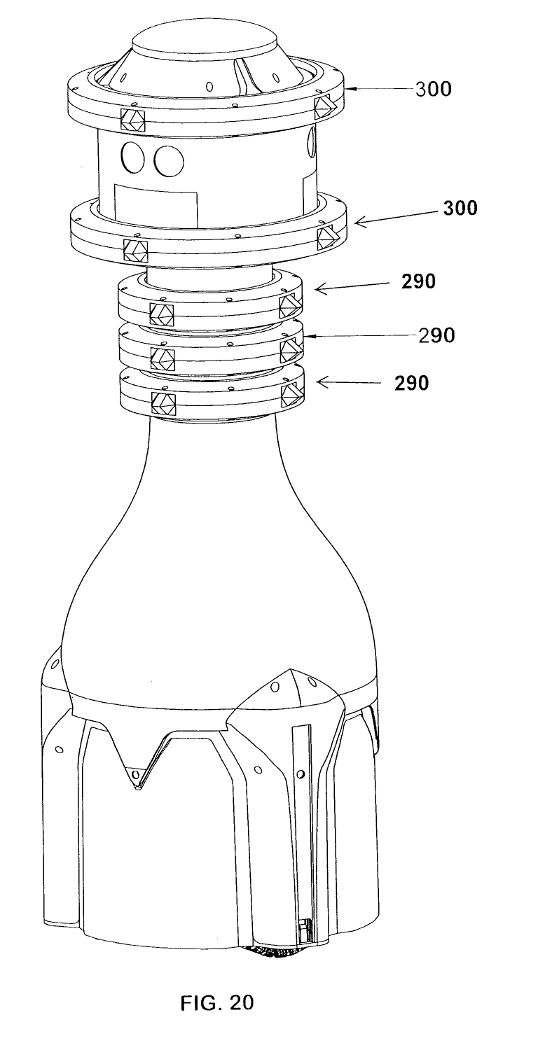

In FIG. 20, two additional spinning disks 300 are provided generally adjacent a top and bottom portion of the head module 14. The structure of this spinning disks 300 are similar to the spinning disks 290 described in FIG. 19 and shown again in FIG. 20.

One advantage of having the spinning disks rotating in opposite directions is to increase the stability of the robot with respect to tipping. The counter rotating disks adds stability and reduces the likelihood of it being pushed over due to a gyroscopic effect.

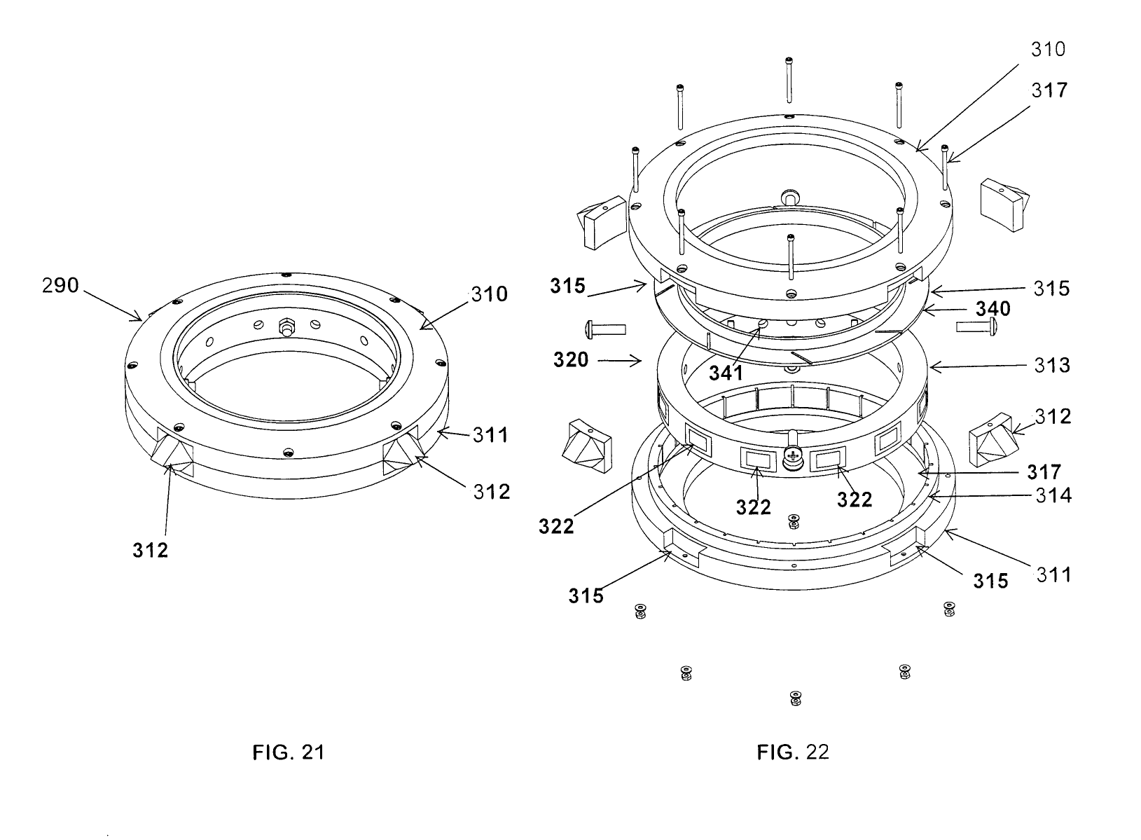

An example of structural details of the spinning disk is shown in FIGS. 21 and 22. The spinning disk 290 includes a lower housing 311, an upper housing 310 and outwardly projecting prism type members 312. The prism type members present a hazard when the disk is spun.

Both the lower housing 311 and the upper housing 310 include mating recesses 315 which receive the projecting prism members 312. The prism members include a mechanical bolt and nut type arrangement for securing of the prisms in the upper and lower housings. The prism members could be projecting steel cutting edges. The upper and lower housings are secured by bolt fasteners 317.

The lower casing 311 is shown with a ring 314 of permanent magnets that are used to spin the disk around the stationary ring 313 having electrical coil magnets 322. The ring 313 is fixed to either the neck or head module and the upper and lower housings rotate around this member when appropriately driven by the electric coil magnets 322. The interior flange 317 of the lower housing 311 can include a separate ring of material acting as a low friction surface separating the spinning disk from the stationary ring 313. A similar low friction ring member 315 is shown that separates the upper housing 310 from the stationary ring 313. This provides a simple arrangement for driving the spinning disks at different speeds as may be required depending upon the particular application.

The nature of the prism members 313 can also change depending upon the particular application. For example, generally rounded projections would still provide a deterrent, however, sharply angled surfaces would provide a much more aggressive deterrent. The fact that the prisms can easily be replaced allows for the defensive mechanism provided by the spinning disks to be varied for a particular purpose.

It is also possible to provide light sources in the spinning upper or lower housing where these light sources are powered by the magnet field of the electrical coils. Such an arrangement provides the advantages of the disks, including spinning light sources without a direct electrical connection of the light sources, to the non-spinning components.

It is apparent that other arrangements are possible to provide the functionality of spinning disks on the mobile security robot to act as a defense mechanism that can be tailored according to the particular application.

From a review of FIGS. 21 and 22, it can be appreciated that the spinning disks include an interior portion thereof which remains stationary and an exterior portion which is driven to rotate at different speeds or a variable speed to act as a deterrent to physical contact.

A suitable arrangement for spinning of the disks has not been described, however, other arrangements can be used. Typically, the neck portion will include a bearing and drive arrangement to allow for the driving of the spinning of the disks and rotation of the spinning disks about the neck and/or head module.

Counter-rotating spinning rings provide a great self-defense for the robot and optionally can include LED messaging while they spin. The counter-rotating spinning disks have a vertical axis to take advantage of the gyroscope effect. Preferably, the system can suddenly adjust the speed of one or more rings to ‘balance’ against a sudden blow to one of more of the rings. This capability, together with the preferred holonomic base, compensates for impacts much like a spinning top. An onboard gyro and accelerator are used to reduce impact forces intended to destabilize. The time-of-flight distance sensors facing downwards (typically 3 sensors) just beyond each wheel provide real-time notice of any wheel (or wheels) lifting off the ground as a result of an impact.

The holonomic robot design without any front/back employing time-of-flight sensors allows fluid movement through crowds of people. It is also important to note that the robot can move in a straight line, yet be spinning slowly on its axis. In such a case, the crowd would not know which direction the hidden payload is facing until it is raised. The robot could also have a sensor, for example, a metal detector or Infrared camera, facing in only one direction, which can actually scan a 360 degree area by using the ability of the robot to spin on its vertical axis while moving in any direction. Thus, one or more sensors, which are directional in nature, could serve to scan in a 360 degree manner without additional mechanics. Furthermore, typical prior art 360 degree sensors must be mounted at the top of a robot so that they have 360 degree views.

In contrast with the present design, the sensors can be lower (lowering the center of mass) while still providing an effective scan. A holonomic robot without any apparent ‘front’ is able to give any directional sensor a 360 degree scanning ability while being mounted anywhere on the robot (preferably closer to the ground).

Although preferred embodiments of the present invention have been described herein in detail, it will be appreciated by those skilled in the art that variations may be made thereto without departing from the appended claims.

1. A security robot comprising a mobile base module and a head module with said head module supported in a raised position above said mobile base module;
said head module including a base member having a wall portion that defines an upwardly opening cavity interior thereto; an inter-changeable payload bucket unit received in said upwardly opening cavity; said inter-changeable payload bucket unit having a displaceable cap member movable between a closed position and an elevated position; said cap member in said closed position closes an upper surface of said upwardly opening cavity and conceals said inter-changeable payload bucket unit; and said cap member in said elevated position is spaced above and allows top access to any payload located in said payload bucket unit.

2. A security robot as claimed in claim 1 wherein said inter-changeable payload bucket unit includes an elevating drive arrangement connected to a platform supporting said displaceable cap member; said elevating drive arrangement when activated moves said platform and cap member upwardly providing clear access to said upwardly opening cavity and said platform.

3. A security robot as claimed in claim 2 wherein said platform is at least partially received and protected in said payload bucket unit when said cap is in said closed position.

4. A security robot as claimed in claim 3 wherein said platform includes a plurality of sensing devices secured thereon, some of which having different or advantageous output signal content at said elevated position.

5. A security robot as claimed in claim 2 or wherein said platform includes one or more of a plurality of defensive and offensive devices secured thereon.

6. A security robot as claimed in claim 2 wherein said elevating drive arrangement includes two screw drive members that pass through said payload bucket unit and connect with said platform and raise or lower said platform with rotation of said two drive members.

7. A security robot as claimed in claim 2 wherein an electric drive motor is a dedicated part of said drive arrangement and is removed as part of said inter-changeable payload bucket unit.

8. A security robot as claimed in claim 1 wherein said inter-changeable bucket unit is a series of inter-changeable bucket units allowing any one of said inter-changeable bucket units to be exchanged with one of said inter-changeable bucket units secured in said mobile security robot.

9. A security robot as claimed in claim 1 including a plurality of outwardly projecting rings selectively driven for spinning about a vertical axis of said security robot.

10. A security robot as claimed in claim 9 wherein said projecting rings, when driven, rotate in opposite directions at similar speeds to increase vertical stability of the security robot.

11. A security robot as claimed in claim 9 wherein said projecting rings include outwardly projecting light transmitting members with angled surfaces capable of damaging or cutting surfaces brought into contact with the projecting rings when driven.

12. A security robot as claimed in claim 9 wherein said projecting rings, when driven, create at least one of a flashing light transmission.

13. A security robot as claimed in claim 3 wherein said mobile base is an omni wheel mobile base.

14. A security robot as claimed in claim 13 wherein said mobile base provide holonomic movement.

15. A security robot as claimed in claim 1 wherein said security robot includes a series of time-of-flight sensors used to assist movement of the mobile security robot in a restricted space.

16. A security robot as claimed in claim 1 wherein said security robot includes directional sensors in combination with rotational movement of the security robot to increase a desired scan area.
